(19) United States
(12) Patent Application Publication
(10) Pub. No.: US 2014/0225908 A1
(43) Pub. Date: Aug. 14, 2014

(54) APPARATUS AND METHOD FOR CONVERTING AN OBJECT FROM VIEWPOINT-RELATIVE COORDINATES TO OBJECT-RELATIVE COORDINATES WITH AN AUXILIARY BUFFER

(71) Applicant: SAMSUNG ELECTRONICS CO. LTD., Suwon-si (KR)

(72) Inventor: Matthew William MARSHALL, Richardson, TX (US)

(73) Assignee: SAMSUNG ELECTRONICS CO. LTD., Suwon-si (KR)

(21) Appl. No.: 13/764,271

(22) Filed: Feb. 11, 2013

(51) Int. Cl. G09G 5/00

(52) U.S. Cl. CPC G09G 5/00
USPC 345/545

(57) ABSTRACT

An apparatus and method for converting an object from viewpoint-relative coordinates to object-relative coordinates are provided. The method includes obtaining an object identifier from an object record of the object, obtaining a minimum x-coordinate and a maximum x-coordinate of the object from the object record, obtaining a minimum y-coordinate and a maximum y-coordinate of the object from the object record, obtaining the x-coordinates and the y-coordinates of the object to be transformed from the viewpoint-relative coordinates to the object-relative coordinates, storing the object identifier of the object to a first channel of an auxiliary buffer, transforming the x-coordinates of the object and storing the transformed x-coordinates to a second channel of the auxiliary buffer, and transforming the y-coordinates of the object and storing the transformed y-coordinates to a third channel of the auxiliary buffer.

### BACKGROUND OF THE INVENTION

1. Field of the Invention

The present invention relates to an apparatus and method which allows a user to apply a non-trivial transformation to an object and to interact with the transformed object. More particularly, the present invention relates to an apparatus and method to convert an object having viewpoint-relative coordinates to an object having object-relative coordinates, storing the object-relative coordinates corresponding to the viewpoint-relative coordinates of the object in a multi-channel auxiliary buffer along with an object identifier used to relate the transformed object to the original object, interacting with the transformed object and reading the stored object identifier and the object-relative coordinates from the multi-channel auxiliary buffer to determine a position where the interaction occurred in the transformed object as if the object was not transformed.

2. Description of the Related Art

In inter-active computer graphics systems a pointing device, such as a mouse, is generally used to move a cursor over a displayed image to point to a particular image element. An action may then be initiated by clicking a mouse button. In order for an application using the graphics system to understand what action is required, the graphics system must translate the image position pointed to by the mouse into a corresponding image element. Conventional graphics systems used to translate the image position pointed to by the mouse into a corresponding image element are well known. An example of such conventional graphics system is disclosed in U.S. Pat. No. 5,448,688 to Hemingway. In Hemingway, to facilitate this translation, the graphics system in generating the output image from a stored group of graphic segments, also generates and stores a compact image representation relating image position to the corresponding segment. This image representation is then subsequently used to translate an input image position back into a segment identity. Furthermore, the input image position is also subject to the reverse of the spatial transformation undergone by the segment during generation of the output image to determine the position in the segment corresponding to the input image position. Therefore, reverse transformations for mapping inputs to transformed graphical objects are stored. However, in conventional inter-active computer graphics systems such as the one described above, in order to map an input, it is necessary to traverse the list of all of the graphical objects and further these systems work only if the applied transformations have a mathematical inverse.

In other inter-active computer graphics systems, such as the one described in U.S. Pat. No. 6,072,506 to Schneider, the objects of a scene are grouped into sets and when rendering a plurality of pixels for display, for each pixel, a set identifier that corresponds to the visible object at the pixel is stored in an auxiliary buffer. The information stored in the auxiliary buffer is utilized during picking in order to avoid traversing all of the objects of the scene to determine those objects intersected by the picking aperture. Therefore, although this interactive computer graphics system has the advantage of not requiring traversing all of the objects of the scene to determine those objects intersected, this system does not address the problem of mapping the point back into the pre-transformed graphical objects.

Accordingly, there is a need for an apparatus and method which allows a user to transform a graphical object into an object having a non-trivial transformation applied to it and to interact with the object having the non-trivial transformation.

### SUMMARY OF THE INVENTION

Aspects of the present invention are to address at least the above-mentioned problems and/or disadvantages and to provide at least the advantages described below. Accordingly, an aspect of the present invention is to provide an apparatus and method to convert an object having viewpoint-relative coordinates to object-relative coordinates using an auxiliary buffer and to interact with the object.

In accordance with an aspect of the present invention, a method for converting an object from viewpoint-relative coordinates to object-relative coordinates is provided. The method includes obtaining an object identifier from an object record of the object, obtaining a minimum x-coordinate and a maximum x-coordinate of the object from the object record, obtaining a minimum y-coordinate and a maximum y-coordinate of the object from the object record, obtaining the x-coordinates and the y-coordinates of the object to be transformed from the viewpoint-relative coordinates to the object-relative coordinates, storing the object identifier of the object to a first channel of an auxiliary buffer, transforming the x-coordinates of the object and storing the transformed x-coordinates to a second channel of the auxiliary buffer, and transforming the y-coordinates of the object and storing the transformed y-coordinates to a third channel of the auxiliary buffer.

In accordance with another aspect of the present invention, a method for converting an object from object-relative coordinates to viewpoint-relative coordinates is provided. The method includes retrieving an object identifier of the object from a first channel of an auxiliary buffer and storing the object identifier in an object record, retrieving minimum x-coordinates and maximum x-coordinates of the object from the object record, retrieving minimum y-coordinates and maximum y-coordinates of the object from the object record, retrieving object-relative x-coordinates of the object from a second channel of the auxiliary buffer and converting the object-relative x-coordinates into viewpoint-relative coordinates, retrieving object-relative y-coordinates of the object from a third channel of the auxiliary buffer and converting the object-relative y-coordinates into viewpoint-relative coordinates, and converting the object from the object-relative coordinates to the viewpoint-relative coordinates.

In accordance with another aspect of the present invention, a computing device for converting an object from object-view-relative coordinates to viewpoint-relative coordinates is provided. The apparatus includes a display for displaying one or more active applications, a input unit for receiving inputs, and a controller for obtaining an object identifier from an object record of the object, obtaining a minimum x-coordinate and a maximum x-coordinate of the object from the object record, obtaining a minimum y-coordinate and a maximum y-coordinate of the object from the object record, obtaining the x-coordinates and the y-coordinates of the object to be transformed from the viewpoint-relative coordinates to the object-relative coordinates, storing the object identifier of the object to a first channel of an auxiliary buffer; transforming the x-coordinates of the object and storing the transformed x-coordinates to a second channel of the auxiliary buffer, and transforming the y-coordinates of the object and storing the transformed y-coordinates to a third channel of the auxiliary buffer.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates an original untransformed graphical object having viewpoint-relative coordinates;

FIG. 2 illustrates a transformed graphical object of FIG. 1 having object-relative coordinates according to an exemplary embodiment of the present invention;

FIG. 3 illustrates a process for transforming an object having viewpoint-relative coordinates to an object having object-relative coordinates according to an exemplary embodiment of the present invention;

FIG. 4 illustrates the transformed graphical object of FIG. 2 including object-relative coordinates according to an exemplary embodiment of the present invention;

FIG. 5 illustrates a user input point in viewpoint relative coordinates on the transformed object of FIG. 2 relative to the screen, according to an exemplary embodiment of the present invention;

FIG. 6 illustrates a user input point in object-relative coordinates on the transformed object of FIG. 2 relative to the screen, according to an exemplary embodiment of the present invention;

FIG. 7 illustrates a process for transforming an object having object-relative coordinates into an object having viewpoint-relative coordinates according to an exemplary embodiment of the present invention;

FIG. 8 illustrates the object-relative coordinates usable for interacting with the original object illustrated in FIG. 1 according to an exemplary embodiment of the present invention;

FIG. 9 is a flowchart illustrating a method of transforming the graphical object and interacting with the graphical object according to an exemplary embodiment of the present invention: and

FIG. 10 is a block diagram of a mobile device according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention include an apparatus and method for converting an object having viewpoint-relative coordinates to object-relative coordinates using an auxiliary buffer and to interact with the object.

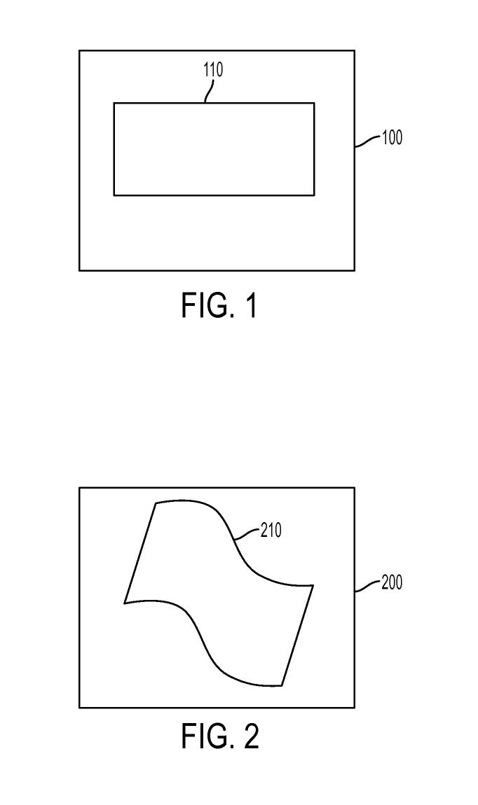

FIG. 1 illustrates an original untransformed graphical object having viewpoint-relative coordinates.

In this case, an untransformed graphical object 110, displayed on a display screen 100 of a display apparatus, is a rectangle. The rectangle is visible to a user on the display screen 100 of the display apparatus. For example, the rectangle can be a graphic displayed on the display screen 100 for a user to enter an instruction through a keyboard or by pointing an icon onto the rectangle with a device such as a mouse and clicking on a mouse button (not shown). It is to be noted that the rectangle illustrated in FIG. 1 is merely an exemplary embodiment of the untransformed graphical object 110 that is displayed on the display screen 100 of the display apparatus and other types of the untransformed graphical object 110 having different shapes and sizes can be displayed on the display screen 100 and are applicable to the transformation of the exemplary embodiments of the present invention.

FIG. 2 illustrates a transformed graphical object of FIG. 1 having object-relative coordinates according to an exemplary embodiment of the present invention

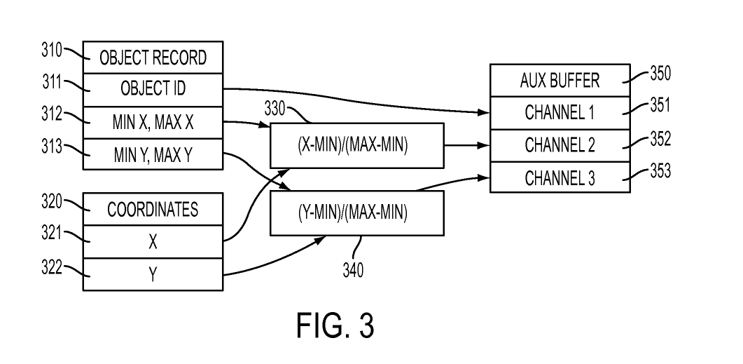

The original, untransformed graphical object, i.e., rectangle illustrated in FIG. 1, is shown as a transformed graphical object 210 in FIG. 2, after undergoing a transformation process according to an exemplary embodiment of the present invention. For example, the rectangle is shown to have been transformed from a 2-dimensional rectangle into a 3-dimensional rectangle or the transformed graphical object 210. That is, the untransformed graphical object 110 of FIG. 1 has undergone a non-trivial transformation according to an exemplary embodiment of the present invention. The transformation process will be explained particularly with respect to FIG. 3. It is also noted that although the above exemplary embodiment illustrates a transformation from a 2-dimensional object to a 3-dimensional object this is merely an exemplary embodiment. For example, the original 2-dimensional graphical object can be transformed to another 2-dimensional object, a 3-dimensioal object can be transformed to another 3-dimensional object, or a 3-dimensional object can be transformed to a 2-dimensioal object, as long as the transformation of the object is a non-trivial transformation.

FIG. 3 illustrates a process for transforming an object having viewpoint-relative coordinates to an object having object-relative coordinates according to an exemplary embodiment of the present invention.

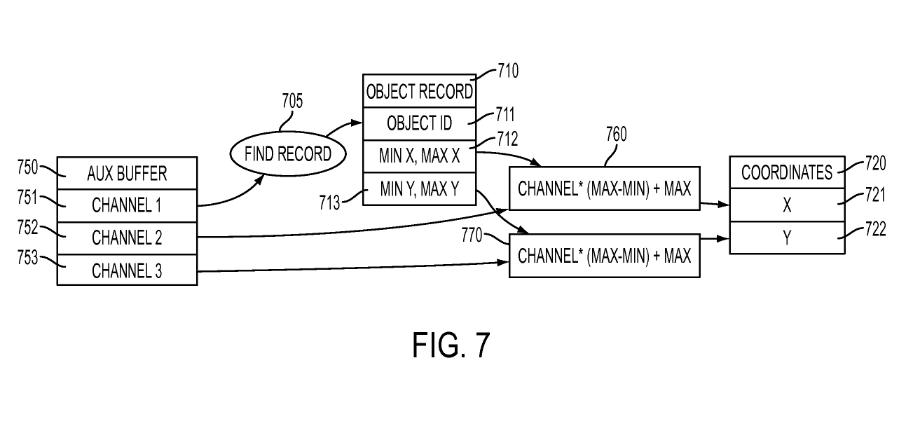

In particular, according to an exemplary embodiment of the present invention. FIG. 3 illustrates a process of encoding object-relative coordinates 321 and 322 into encoded object-relative coordinates and storing the obtained encoded-relative coordinates in second and third channels 352 and 353 of a multi-channel auxiliary buffer 350. In addition, the multi-channel auxiliary buffer 350 stores an object identifier or an object identifier 311 in a first channel 351 which will be used to obtain an object record 310 in a process described in FIG. 7. Accordingly, the information stored in the multi-channel auxiliary buffer 350 illustrated in FIG. 3 will be used in a transformation process using viewpoint-relative coordinates to object-relative coordinates which will be explained in detail with respect to FIG. 7.

Referring back to FIG. 3, a multi-channel auxiliary picking buffer or the multi-channel auxiliary buffer 350 is used to store the obtained encoded object-relative coordinates in the second and third channels 352 and 353 as well as to store the object identifier 311 in the first channel 351. In contrast to conventional art systems which utilize a single channel auxiliary buffer to store only an object identifier (Object ID), according to an exemplary embodiment of the present invention, the multi-channel auxiliary picking buffer 350 is utilized. It is noted that the term auxiliary buffer, multi-channel auxiliary picking buffer, multi-channel buffer and multi-channel auxiliary buffer are utilized interchangeably through the specification to indicate a buffer having more than one channel.

Since there is a relationship between display/input coordinates and auxiliary buffer coordinates as described below, the object identity or object identifier 311 and the object-relative coordinates inside the transformed object can be determined. Therefore, aspects of the present invention can be utilized even for transformations without a mathematical inverse and the user can interact with the transformed object as if the object was never transformed.

Due to the relationship between the auxiliary buffer coordinates, the device display coordinates, and the input system coordinates, it is assumed that the input system coordinates have already been converted to device display coordinates, and this process will not be explained in detail for it is a known conventional process. In the simple case, there is a one-to-one relationship between the auxiliary buffer and the device display, such that information related to an object displayed at any given x,y display coordinate will be stored in the same x,y coordinate in the auxiliary buffer. However, the auxiliary buffer coordinates may represent a subset (or superset) of the device display coordinates, and may be stored at a different resolution, requiring the coordinates to be translated and/or scaled to find the auxiliary buffer coordinates that corresponds to the display/input coordinate.

When converting the object having viewpoint-relative coordinates to an object having object-relative coordinates and saving the encoded object-relative coordinates in the multi-channel auxiliary buffer 350, the same geometry and transformations are used as were drawn to a device display 200. The drawing system must draw to both the device display 200 and to the multi-channel auxiliary buffer 350. This may be done in a single pass on drawing systems that support multiple drawing targets. Or it may be split into separate passes, with the two passes sharing the same geometry but differing in which buffer they are drawing to and in what data is stored. Therefore, the pixels of the transformed object displayed to the user on the device display 200 of a display apparatus have corresponding pixels stored in the multi-channel auxiliary buffer 350 containing information pertaining to the graphical object visible at the pixel. However, the bytes stored in the multi-channel auxiliary buffer 350 are used to decode the encoded object-relative coordinates stored in the multi-channel auxiliary buffer 350 as will be explained in FIG. 7. For example, if a 3-channel buffer was utilized to store the data, the channels of the multi-channel auxiliary buffer 350 could include information in Table 1:

TABLE 1

| Channel: | Data: |
|---|---|
| First Channel | Object Identifier |
| Second Channel | X coordinate |
| Third Channel | Y coordinate |

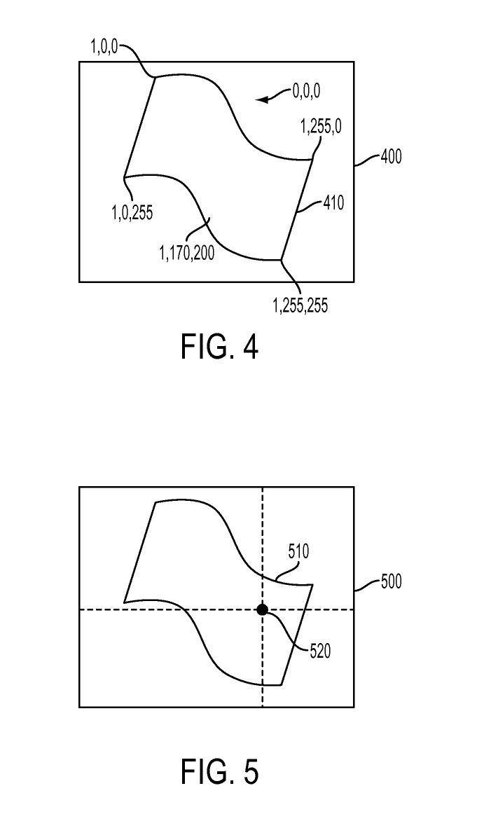

An X and Y coordinates 320 is relative to the graphical object. They may be scaled to utilize the full range of the bits available per channel. For example, in a buffer with 8 bits per channel, a second channel value of 0 would designate a far left side of the object displayed on the screen, while a second channel value of 255 (the maximum number stored in 8 bits) would designate the far right side of the object displayed on a screen. Similarly, in the same 8 bit buffer, a third channel value of 0 would designate an upper most side of the object displayed on the screen, while a third channel value of 255 (the maximum number stored in 8 bits) would designate the lower most side of the object displayed on the screen. For example, FIG. 4 illustrates various values of the X and Y coordinates 320 of a transformed object stored in the multi-channel auxiliary buffer 350, assuming that the object identifier 311 has a value of 1.

Below is described in detail the process to obtain the information that will be stored in the multi-channel auxiliary buffer 350, and which will be used in the transformation process from viewpoint-relative to object-relative as illustrated in FIG. 7.

In order to obtain the information which will be stored in the second and third channels 352 and 353 of the multi-channel auxiliary buffer 350, the object record 310 and the X and Y coordinates 320, such as the X and Y coordinates 321, 322, respectively, of the untransformed graphical object 110 are used. The object record 310 includes the object identifier 311, a maximum and minimum X coordinates 312 and a maximum and minimum Y coordinates 313 of the untransformed graphical object 110.

In particular, the object record 310 stores data that is common across the entire object (and does not vary per pixel.) This may include data needed for converting values stored in the multi-channel auxiliary buffer 350 to coordinates, or other application specific data. In addition, Channel 1 or the first channel 351 of the multi-channel auxiliary buffer 350 stores the object identifier 311. Channel 2 or the second channel 352 stores the result of operation 330. That is, the second channel 352 of the multi-channel auxiliary buffer 350 stores the encoded object-relative X coordinate. Finally, Channel 3 or the third channel 353 of the multi-channel auxiliary buffer 350 stores the result of operation 340. That is, the third channel 353 of the multi-channel auxiliary buffer 350 stores the encoded object-relative Y coordinate. This is one possible embodiment of encoding the coordinates to/from data that can be stored in the multi-channel auxiliary buffer 350. By storing the minimum and maximum extents of the object's coordinates 312, 313 in the object record 310, the object's coordinates can be encoded in a way that utilizes the full range of numbers capable of being stored in the multi-channel auxiliary buffer 350. Operations 330 and 340 calculate the ratio that is the coordinate between the minimum and maximum coordinates of the object in the x and y-axes. The result is in the range from 0 to 1, which can be trivially encoded in the multi-channel auxiliary buffer 350. Operation 770 illustrated in FIG. 7 is an inverse of operation 340, taking a value from 0 to 1 from the multi-channel auxiliary buffer 350 and the Min/Max coordinates from the object record 310 to derive the decoded coordinate. As noted above, the object identifier 311 does not undergo any transformation and is stored in the first channel 351 of the multi-channel auxiliary buffer 350.

However, it is noted that this is merely an exemplary embodiment and the data can be stored in different channels of the multi-channel auxiliary buffer 350 or in a multi-channel buffer having more or less than three channels.

It is also noted that this form of encoding and storing the coordinate in the multi-channel auxiliary buffer 350 is mostly useful for an auxiliary buffer that stores low precision and/or fixed point numbers. Some graphics hardware can operate on buffers that store high precision floating point numbers, in which case encoding the coordinate as a linear blend between the minimum and maximum would not be necessary. Also, the linear blend used assumes that precision along the full range of the object's coordinates is equally important. If an application requires a higher precision along a certain range than another, a different blend equation could be used. One aspect of this embodiment is the use of additional data stored in the Object Record to better use the precision available in the auxiliary buffer.

Once the original graphical object has been transformed and the data of the transformed graphical object 210 has been stored in the multi-channel auxiliary buffer 350, the user can easily interact with the transformed graphical object 210 and commands input or entered on the transformed graphical object 210 can be easily determined as if no transformation has been performed by reading the object information stored in the multi-channel auxiliary buffer 350.

FIG. 4 illustrates the transformed graphical object of FIG. 2 including object-relative coordinates according to an exemplary embodiment of the present invention.

As noted above, the X and Y coordinates 320 are relative to a graphical object 410. They may be scaled to utilize the full range of the bits available per channel. For example, in a buffer with 8 bits per channel, a second channel value of 0 would designate a far left side of the graphical object 410 displayed on a screen 400, while a second channel value of 255 (the maximum number stored in 8 bits) would designate the far right side of the graphical object 410 displayed on the screen 400. Therefore, the X coordinates stored in the second channel 352 reflecting the far left side of the graphical object 410 would have a value of 0 and the X coordinates reflecting the far right side of the graphical object 410 would have a value of 255. Similarly, in the same 8 bit buffer, a third channel value of 0 would designate an upper most side of the graphical object 410 displayed on the screen 400, while a third channel value of 255 (the maximum number stored in 8 bits) would designate the lower most side of the graphical object 410 displayed on the screen 400. Therefore, the Y coordinates stored in the third channel 353 reflecting the upper most side of the object would have a value of 0 and the Y coordinates reflecting the lower most side of the graphical object 410 would have a value of 255. For example, FIG. 4 illustrates various values of the X and Y coordinates 320 of the transformed graphical object 410 stored in the multi-channel auxiliary buffer 350, assuming that the object identifier 311 has a value of 1.

FIG. 5 illustrates a user input point in viewpoint relative coordinates on the transformed object of FIG. 2 relative to the screen according to an exemplary embodiment of the present invention.

As illustrated in FIG. 5, a user can enter an input on a specific area of a transformed graphical object 510 relative to a screen 500 of the display unit. For example, if a user enters a command at a specific input point 520 of the transformed graphical object 510 as illustrated in FIG. 5, the object relative coordinates are read from the multi-channel auxiliary buffer 350 to determine the specific point where the command was entered relative to the original untransformed object.

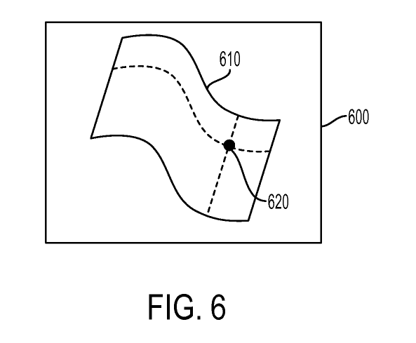

FIG. 6 illustrates the user input point in object-relative coordinates on the transformed object of FIG. 2 relative to the screen, according to an exemplary embodiment of the present invention.

According to an exemplary embodiment of the present invention, to determine the object-relative coordinates with respect to an input location 620 of a transformed graphical object 610 displayed on a screen 600, the data stored in a multi-channel auxiliary buffer 750 is decoded into object-relative coordinates, as illustrated in FIG. 7.

FIG. 7 illustrates a process for transforming viewpoint-relative coordinates into object-relative coordinates according to an exemplary embodiment of the present invention.

Particularly, according to an exemplary embodiment of the present invention, the encoded object-relative coordinates 352 and 353 as well as the object identifier 351, generated in the process described above with respect to FIG. 3 in combination with the view-point relative coordinates are utilized to generate the decoded object-relative coordinates 721 and 722. Therefore, the viewpoint-relative coordinates, which are input to the apparatus, for example, from the user's input device, are used for determining which values to read from the multi-channel auxiliary buffer 350. As noted above, these values are the values stored in the respective channels 351, 352 and 353 of the multi-channel auxiliary buffer 350 sampled from the location in the multi-channel auxiliary buffer 350 that corresponds to the viewpoint relative coordinates. For example, 752 and 753 are the object-relative coordinates encoded to best utilize the range of numbers storable in the auxiliary buffer. Operations 760 and 770 are processes of decoding the object relative coordinates. A maximum and minimum X coordinates 712 and a maximum and minimum Y coordinates 713 are values needed for the decoding process. 721 and 722 are the object-relative coordinates after decoding.

As noted in FIG. 7, the multi-channel auxiliary buffer 750 stores the encoded object-relative coordinates 752 and 753 of the transformed graphical object as well as the object identifier in respective channels 751-753. However, it is noted that this is an exemplary embodiment of the present invention and therefore, the multi-channel auxiliary buffer 750 can store more or less data regarding the transformed object. Similarly, although the exemplary embodiment describes a 3 channel auxiliary buffer, it is noted that the auxiliary buffer may contain more or less than 3 channels.

As illustrated in FIG. 7, in order to decode the encoded object-relative coordinates stored in the respective second and third channels 752 and 753 of the multi-channel auxiliary buffer 750, data related to the object identifier stored in a first channel 751 as well as the X and Y object-relative coordinates stored in the second and third channels 752, 753 of the transformed object are retrieved from the multi-channel auxiliary buffer 750. Thereafter, in combination with information stored in an object record 710, the encoded X and Y object-relative coordinates are decoded back into an object-relative coordinates 720. Particularly, FIG. 7 illustrates the process of decoding the encoded object-relative coordinates stored in the multi-channel auxiliary buffer 750. 752 and 753 are the object-relative coordinates encoded in a form to better utilize the available numerical precision of the auxiliary buffer. See the above discussion on FIG. 3. FIG. 7 is a reverse operation of FIG. 3.

As noted above, the multi-channel auxiliary buffer 750 stores the object identifier in the first channel 751 as well as the encoded X and Y object-relative coordinates in respective second and third channels 752 and 753. Meanwhile, the object record 710 stores an object identifier 711, the maximum and minimum X coordinates 712 of the transformed object and the maximum and minimum Y coordinates 713 of the transformed object.

Accordingly, in order to decode the encoded X and Y object-relative coordinates stored in respective second and third channels 752, 753 back into the decoded X and Y object-relative coordinates 720, the encoded X object-relative coordinates are retrieved from the second channel 752 of the multi-channel auxiliary buffer 750 and undergo a conversion process in operation 760 in combination with the minimum and maximum X coordinates 712 stored in the object record 710. Similarly, the encoded Y object-relative coordinates are retrieved from the third channel 753 of the multi-channel auxiliary buffer 750 and undergo a conversion in operation 713 in combination with the minimum and maximum Y coordinates 713 stored in the object record 710.

Therefore, due to this transformation process, the user can interact with the transformed graphical object, using a pointing device such as a mouse or through a user's touch if the screen was a touch screen, as if the graphical object was not transformed.

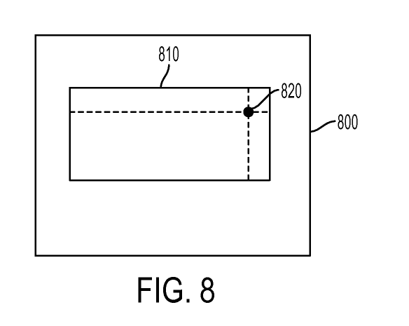

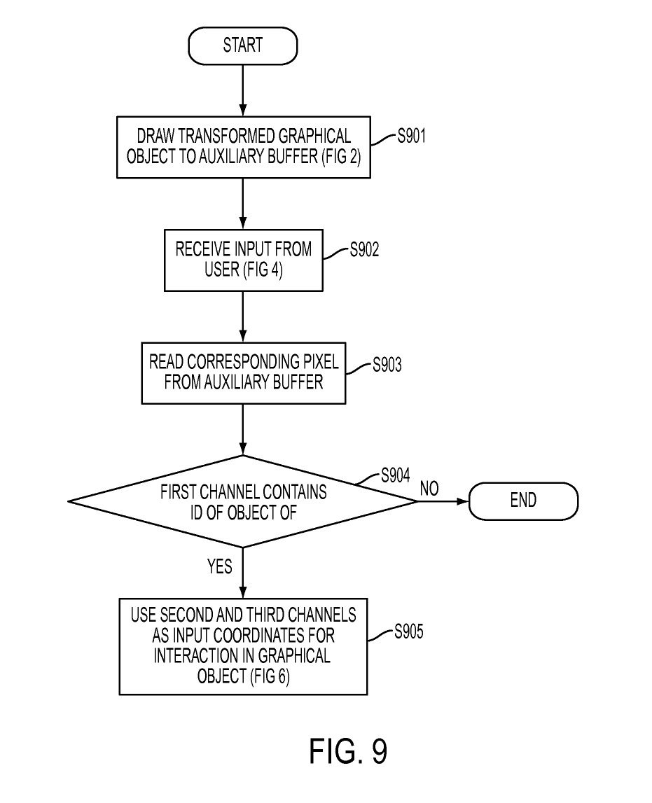

This is due to the fact that information regarding the location of the pixel associated with the location specified by the user is read from the multi-channel auxiliary buffer. By reading the respective channels of the multi-channel auxiliary buffer, the specific location of the transformed object relative to the original object can be determined and respective processes associated with the pixel interaction can be performed. Accordingly, it is possible for the user of the device to interact with the transformed object illustrated in FIG. 6 as if the transformed object would have never been transformed as illustrated in FIG. 8.

FIG. 8 illustrates the object-relative coordinates usable for interacting with the original object illustrated in FIG. 1 according to an exemplary embodiment of the present invention.

According to an exemplary embodiment of the present invention, the object having object-relative coordinates illustrated in FIG. 6 displayed on a screen 800 is converted back into an object 810 having viewpoint-relative coordinates and an input location 820 is determined as if the object 810 was never transformed. More particularly, FIG. 8 shows that the object 610 can be interacted with as if it has been displayed as the object 810. The object 810 need not actually exist, and a conversion back to viewpoint-relative coordinates need not happen if the object's interaction logic only requires object-relative coordinates.

FIG. 9 is a flowchart illustrating a method of transforming the graphical object and interacting with the graphical object according to an exemplary embodiment of the present invention.

More particularly, FIG. 9 is a flowchart illustrating a method of transforming the graphical object having viewpoint-relative coordinates to the graphical object having object-relative coordinates and interacting with the transformed graphical object according to an exemplary embodiment of the present invention.

Initially, an untransformed object is displayed on a screen of a display apparatus as illustrated in FIG. 1. Thereafter, at operation S901, a user transforms the graphical object having viewpoint-relative coordinates to a graphical object having object-relative coordinates and data of the transformed coordinates of the graphical object is stored in the multi-channel auxiliary buffer according to the processes described in FIG. 3 of the present application. The object need not have been transformed by the user, and need not have ever been displayed in a non-transformed form. FIG. 1 shows how the object in FIG. 2 would appear if it were drawn without transformations. Operation S901 is the setup step required to prepare the auxiliary buffer and FIG. 3 describes part of what happens in operation S901.

At operation S902, the user of the display apparatus enters an input command on the screen of the display apparatus at a particular point or pixel of the transformed graphical object. The input command can vary according to the type of display apparatus. For example, if the display apparatus is a conventional display apparatus, the input command is entered by pointing an icon on a particular position of the graphical object and clicking a mouse or depressing a key on a keyboard. Similarly, if the display apparatus comprises a touch screen, the input command can be entered through a user's touch. However, it is noted that the input command is not limited to the examples noted above and various other types of input commands can be used to interact with the transformed object. For example, a user can use a stylus to enter a command

At operation S903, once the input command has been entered onto a particular position, such as for example a particular pixel, of the transformed object, information corresponding to that particular pixel is read from the auxiliary buffer The relationship between display pixels and auxiliary buffer pixels is discussed above. Meanwhile, FIG. 7 describes how the data read from the appropriate auxiliary buffer is decoded into the object-relative coordinates and relates to operation S905.

Thereafter, at operation S904, at determination is made as to whether the first channel of the auxiliary buffer contains the object identifier of the object of interest. An example of determining whether the first channel of the auxiliary buffer contains the object identifier of the object of interest, i.e., finding the record in the first channel is described above with reference to FIG. 7, and therefore a detailed description of such process will be omitted. If determined that the first channel of the multi-channel auxiliary buffer does not contain the object identifier of the object of interest, the process is terminated. The operation “Find Record” (705) could be any data structure or algorithm for storing the object records and returning one with the matching id. For example, a binary tree with the object id as the key.

Meanwhile, if determined that the object identifier is found in the first channel of the multi-channel buffer, as noted at operation S905, information regarding the encoded object-relative coordinates of the object are retrieved from the second and third channels of the multi-channel auxiliary buffer and in combination with the viewpoint-relative coordinates the encoded object-relative coordinates are decoded and the decoded objet-relative coordinates are obtained and usable for interacting with the object as if the object was not transformed.

It is also noted that the exemplary embodiments of the present application can be utilized in various types of application. For example, the exemplary embodiments can by utilized in applications which allow the user to visualize 3d models and mark areas of interest on them. The user can thereafter perform various transformations on the 3d model. For example, the user can scale a portion of the model to be larger or smaller. Or, convert a concave portion of the model's surface to be convex for better visualization. While the model is transformed, the user can place markers on areas of interest on the surface of the models. These object-relative coordinates of these markers are determined using the method disclosed in this application. Since the areas of interest marked by the user are stored in object-relative coordinates, the various transformations on the 3d models can be reverted (to display the original model) with the mark locations being preserved.

Finally, it is noted that the above described exemplary embodiments can be implemented in various types of electronic devices or apparatuses. For example, an electronic device in which the above described exemplary embodiments can be implemented include a smartphone, a tablet computer or on any other type of computing device having a display and a user input. Therefore the devices can include but are not limited to a general purpose computer, a mobile device, an electronic tablet, or a workstation.

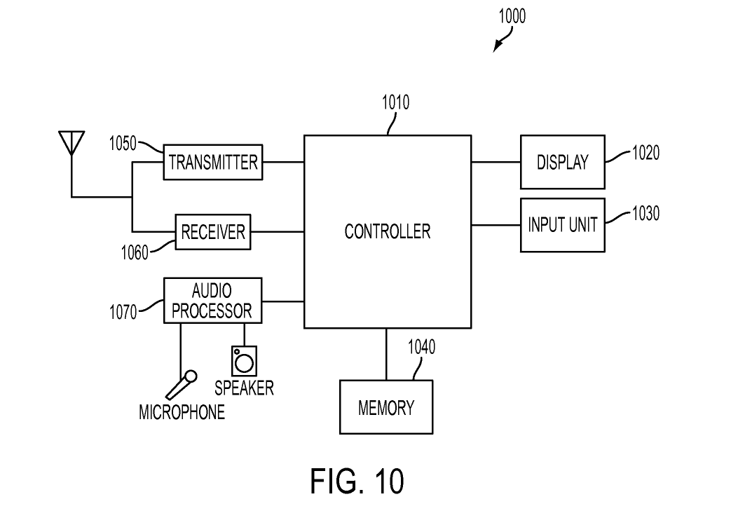

FIG. 10 is a block diagram of a mobile device according to an exemplary embodiment of the present invention.

Referring to FIG. 10, a mobile device 1000 according to an exemplary embodiment of the present invention includes at least one controller 1010, a display 1020 for displaying an active first application, and an input unit 1030 for receiving inputs. In some embodiments, the display 1020 and the input unit 1030 may be combined as a touchscreen, although the present invention is not limited thereto.

The mobile device 1000 may include a memory 1040 for storing programs and data. The programs may include an OS and applications, such as the one described above with respect to the exemplary embodiments. If the memory 1040 is present, it may include any form of memory that the controller 1010 can read from or write to.

The mobile device 1000 may include a transmitter 1050 and a receiver 1060 for wireless communication, such as a telephone function or a wireless internet function. The mobile device 1000 may also include an audio processor 1070, a microphone MIC, and a speaker SPK, for audio communication.

The mobile device 1000 will include a function, either readable as a program from the memory 1040 or embodied as hardware in the controller 1010, to allow a user to select a location using the input unit 1030 of an application displayed on the display 1020, and to drag the selected location to a different position, thereby providing the functions described above with respect to the exemplary embodiments.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for converting an object from viewpoint-relative coordinates to object-relative coordinates, the method comprising:
obtaining an object identifier from an object record of the object;
obtaining a minimum x-coordinate and a maximum x-coordinate of the object from the object record;
obtaining a minimum y-coordinate and a maximum y-coordinate of the object from the object record;
obtaining the x-coordinates and the y-coordinates of the object to be transformed from the viewpoint-relative coordinates to the object-relative coordinates;
storing the object identifier of the object to a first channel of an auxiliary buffer;
transforming the x-coordinates of the object and storing the transformed x-coordinates to a second channel of the auxiliary buffer; and
transforming the y-coordinates of the object and storing the transformed y-coordinates to a third channel of the auxiliary buffer.

2. The method of claim 1, wherein the object identifier is stored directly onto the first channel of the auxiliary buffer.

3. The method of claim 1, wherein the x-coordinates are transformed according to the following equation:
x−x-Min/(x-Max−x-Min),
wherein x represents the x-coordinate, x-Min represents the minimum x-coordinate, and x-Max represents the maximum x-coordinate of the object.

4. The method of claim 1, wherein the y-coordinates are transformed according to following equation:
y-y-Min/(y-Max−y-Min),
wherein y represents the y-coordinate, y-Min represents the minimum y-coordinate, and y-Max represents the maximum y-coordinate of the object.

5. A method for converting an object from object-relative coordinates to viewpoint-relative coordinates, the method comprising:
retrieving an object identifier of the object from a first channel of an auxiliary buffer and storing the object identifier in an object record;
retrieving minimum x-coordinates and maximum x-coordinates of the object from the object record;
retrieving minimum y-coordinates and maximum y-coordinates of the object from the object record;
retrieving object-relative x-coordinates of the object from a second channel of the auxiliary buffer and converting the object-relative x-coordinates into viewpoint-relative coordinates;
retrieving object-relative y-coordinates of the object from a third channel of the auxiliary buffer and converting the object-relative y-coordinates into viewpoint-relative coordinates; and
converting the object from the object-relative coordinates to the viewpoint-relative coordinates.

6. The method of claim 5, wherein the object identifier is retrieved directly from the first channel of the auxiliary buffer.

7. The method of claim 5, wherein the object-relative x-coordinates are encoded according to the following equation:
object-relative x-coordinates*(maximum x-coordinates−minimum x-coordinates)/maximum x-coordinates.

8. The method of claim 5, wherein the object-relative y-coordinates are encoded according to the following equation:
object-relative y-coordinates*(maximum y-coordinates−minimum y-coordinates)/maximum y-coordinates.

9. A computing device for converting an object from object-relative coordinates to viewpoint-relative coordinates, the computing device comprising:
a display for displaying one or more active applications;
a input unit for receiving inputs; and
a controller for obtaining an object identifier from an object record of the object; obtaining a minimum x-coordinate and a maximum x-coordinate of the object from the object record; obtaining a minimum y-coordinate and a maximum y-coordinate of the object from the object record; obtaining the x-coordinates and the y-coordinates of the object to be transformed from the viewpoint-relative coordinates to the object-relative coordinates; storing the object identifier of the object to a first channel of an auxiliary buffer; transforming the x-coordinates of the object and storing the transformed x-coordinates to a second channel of the auxiliary buffer; and transforming the y-coordinates of the object and storing the transformed y-coordinates to a third channel of the auxiliary buffer.

10. The computing device of claim 9, wherein the object identifier is stored directly onto the first channel of the auxiliary buffer.

11. The computing device of claim 9, wherein the x-coordinates are transformed according to the following equation:
x−x-Min/(x-Max−x-Min),
wherein x represents the x-coordinate, x-Min represents the minimum x-coordinate, and x-Max represents the maximum x-coordinate of the object.

12. The computing device of claim 9, wherein the y-coordinates are transformed according to following equation:
y−y-Min/(y-Max−y-Min),
wherein y represents the y-coordinate, y-Min represents the minimum y-coordinate, and y-Max represents the maximum y-coordinate of the object.
